(19) United States
(12) Patent Application Publication
(10) Pub. No.: US 2018/0040887 A1
(43) Pub. Date: Feb. 8, 2018

(54) SODIUM-ION BATTERY ANODE

(71) Applicant: NATIONAL UNIVERSITY OF SINGAPORE, Singapore (SG)

(72) Inventors: Balaya PALANI, Singapore (SG); Ashish RUDOLA, Singapore (SG)

(21) Appl. No.: 15/553,082

(22) PCT Filed: Feb. 25, 2016
(86) PCT No.: PCT/SG2016/050094

§ 371 Date: Aug. 23, 2017

Related U.S. Application Data
(60) Provisional application No. 62/120,463, filed on Feb. 25, 2015.

(51) Int. Cl. H01M 4/485; H01M 4/04; H01M 10/056; H01M 4/62; H01M 10/054

(52) U.S. Cl. CPC H01M 4/485; H01M 4/621; H01M 4/625; H01M 10/054; H01M 10/056; H01M 4/04; H01M 2004/027

(57) ABSTRACT

The present invention relates to an electrode material for a sodium-ion battery, in particular, the present invention relates to an electrode material suitable for use as an anode of a sodium-ion battery wherein the electrode material comprises sodium titanate. In an aspect of the present invention, the electrode material comprises a sodium titanate having the formula Na₃₊ₓTi₃O₇, wherein the value of x is defined as −0.5≦x≦0.3, wherein said material is an intermediate phase between Na₂Ti₃O₇ and Na₃₊ₓTi₃O₇.

The present invention relates to an electrode material for a sodium-ion battery. In particular, the present invention relates to an electrode material suitable for use as an anode of a sodium-ion battery wherein the electrode material comprises sodium titanate.

With the growing concerns about global warming in the recent years, much emphasis has been placed towards shifting from fossil fuel based energy harvesting plants to those relying on renewable sources of energy such as solar and wind. The intermittency of these sources results in the unavoidable need for energy storage. In this new age of renewable sources, energy storage in the form of stationary grid batteries will be as critical as the actual solar/wind farms and their performance as an integrated system will determine their market success. To the latter point, cost of these grid batteries would be the most critical. Lithium-ion batteries (LIBs), which are the state of the art and easily outstrip other traditional battery technologies in terms of performance, are ill-suited for grid application owing to the limited availability of lithium reserves. Furthermore, concerns about lithium's future price, especially when demand increases in the future owing to the rapid escalation of demand of LIBs for applications such as electric vehicles, would require an alternate battery technology that does not rely on lithium, yet has comparable performance to LIBs.

In this regard, room temperature sodium-ion batteries (NIBS) are very well suited since they have the same working principle as LIBs and recent reports suggest that they can rival or even surpass LIBs in terms of performance. Switching to NIBs would make sense since sodium is widely abundant and a battery technology relying on sodium would be much cheaper than that relying on lithium.

NIBs, similar to LIBs, require a cathode material capable of inserting/de-inserting sodium ions at a high potential, and an anode material capable of doing the same at low potentials. Obviously, the higher the operating potential of the cathode, termed as the “redox potential” (reduction/oxidation), and the lower the redox potential of the anode, the higher would be the operating potential of the full cell. The energy density of a full cell (the amount of energy stored per weight with the units typically being Wh/Kg) is equal to the operating potential (V) times the capacity of its cathode or anode (the amount of charge stored per weight of the electrode material, mAh/g). For grid storage batteries, unlike those needed for electric vehicles and consumer electronics, energy density is not the most important performance factor since there are no restrictions on the weight and size of these batteries. The primary factors instead are low cost, ultra-long cycle life, excellent safety and high round-trip energy efficiency (RTEE) of at least 80%. The RTEE is a product of the coulombic efficiency (ratio of the discharge capacity to the charge capacity) and the voltage efficiency (hysteresis in the voltage between the charge and discharge cycles). With these points in mind, the energy density of a full cell can easily be increased by increasing the operating potential of the full cell, this means combining a high potential cathode with a low potential anode. Also, the RTEE can be increased by ensuring that there is negligible voltage hysteresis (also called “polarization”) between the charging and discharging curves of the full cell. Since a full cell's galvanostatic curves are nothing but those of the anode subtracted from that of the cathode, what this means is that the individual galvanostatic curves of the cathode and anode (measured typically versus sodium metal in a “half-cell” approach) should exhibit very little voltage polarization.

Energy storage for the grid will be a vital component towards ushering in the age of the renewable sources of energy such as solar and wind as it solves the most glaring drawback of them—their intermittency. Hence, a cheap battery meant for grid application will make the cost of electricity coming from these plants very cost competitive for the consumers. Since cost is a big factor, LIBs are automatically disqualified owing to the lack of abundance of lithium resources. NIBs, relying on the globally abundant and therefore cheap sodium, are the best candidates.

While there have been some promising high voltage cathodes already demonstrated for NIBs, a suitable combination of a very low voltage redox potential and an attractive capacity anode material has not been demonstrated. Carbon based anodes for NIBs may have a high capacity and very low redox potential (<0.1 V vs Na/Na⁺), but they have serious safety concerns owing to the thermal instability of the sodiated material at low temperatures of around 100-150° C. as well as the possibility of sodium plating on the anode which may cause as internal short-circuit due to voltages dangerously close to 0 V.

Hence, there is a need for discovering electrode materials capable of storing sodium at attractive voltages with decent capacity, having low synthesis costs, able to display an ultra-long cycle life, having a high RTEE and being thermally stable in the sodium deficient and rich phases.

The listing or discussion of an apparently prior-published document in this specification should not necessarily be taken as an acknowledgement that the document is part of the state of the art or is common general knowledge.

Any document referred to herein is hereby incorporated by reference in its entirety.

In the present invention, we have discovered a new phase in the sodium titanates, that of Na₃Ti₃O₇. This material may be used as an anode in sodium ion batteries because, as an anode, it can store sodium in the lowest voltage ever reported for any non-carbon based anode material used in sodium-ion batteries. Our current findings demonstrate its very suitable low voltage sodium storage activity along with its attractive capacity which results in a high energy density full sodium-ion cell with the highest voltage plateau every reported in sodium-ion batteries for non-carbon based materials. Other attractive capabilities for battery application such as extremely good high rate performance, long cycle life, high efficiency, use of low cost materials as well as great thermal stability are also presented. It is envisaged that this material may play a key role in not just lithium/sodium based batteries, but also in other fields such as electrochromic windows, water splitting and catalytic reactions.

The most promising non-carbon anode material is the insertion based sodium titanate Na₂Ti₃O₇, which has been shown to intercalate two moles of sodium (to nominally form Na₄Ti₃O₇) at an average potential of 0.3 V vs Na/Na⁺ with a high capacity of 178 mAh/g. While it sounds very promising, there is a big drawback in this material. It displays a huge polarization in its charge and discharging potentials, being >0.4 V and <0.2 V, respectively. This >0.2 V difference will lead to a full cell operating with low RTEE.

Here, we present another sodium storage route for Na₂Ti₃O₇ that involves limiting its sodium uptake to just one mole, forming the previously unknown “Na₃Ti₃O₇” phase. This Na₂Ti₃O₇<=>Na₃Ti₃O₇ sodium storage pathway results in the lowest redox voltage of 0.20 V ever reported for a non-carbon based anode material with an attractive theoretical capacity of 88.9 mAh/g. It will also be demonstrated that there is very little voltage polarization in the charging and discharging curves of this material. When combined with a high voltage cathode, this material results in a high energy density full cell showing a high RTEE as well as an extremely high voltage plateau between 4 and 3.7 V vs Na/Na⁺. This would be the highest plateau displayed thus far for any non-carbon based NIB. In addition, the extremely good rate performance, excellent thermal stability and long cycle life for this material will be displayed.

In an aspect of the present invention, there is provided an electrode material for a sodium ion battery, the material comprising a sodium titanate having the formula Na₃₊ₓTi₃O₇, wherein the value of x is defined as −0.5≦x≦0.3.

In an embodiment, the sodium titanate has a formula of Na₃Ti₃O₇, i.e. Na₃₊ₓTi₃O₇ (where x≈0), or Na₃₋ₓTi₃O₇ (where x≈0). In this application, when the formula Na₃₋ₓTi₃O₇ is used, it is also meant to refer to the scenario where x≈0, giving rise to the formula Na₃Ti₃O₇.

Preferably, the electrode is an anode, and the material is an intermediate phase between Na₂Ti₃O₇ and Na₃₊ₓTi₃O₇ when cycled against a cathode material having a higher voltage in an electrolyte. Preferably, the anode material is an intermediate phase between Na₂Ti₃O₇ and Na₄Ti₃O₇ when cycled against a cathode material having a higher voltage in an electrolyte. Preferably, that intermediate phase is Na₃Ti₃O₇. Preferably, the cathode material is a sodium metal. The starting electrode (anode) material Na₂Ti₃O₇, which may be synthesized by any suitable means, transforms to Na₃₊ₓTi₃O₇ (−0.5≦x≦0.3) in the course of cycling such that the electrode goes from Na₂Ti₃O₇ to Na₃₊ₓTi₃O₇ (−0.5≦x≦0.3) during discharge in a half cell (in a full cell, the process would be the charge cycle) and back from Na₃₊ₓTi₃O₇ (−0.5≦x≦0.3) to Na₂Ti₃O₇ during the charge process in a half cell (in a full cell, the corresponding process would be the discharge).

Any suitable electrolyte may be used, particularly any electrolyte suitable for an aqueous sodium-ion battery or non-aqueous sodium-ion battery of the present invention, or even any other solid-state batteries which use this Na₃₊ₓTi₃O₇ (−0.5≦x≦0.3) as anode. As such, the present invention includes any such electrolyte that is able to allow sodium ions to be shuttled from the cathode to the anode and vice versa. Such electrolytes may be ether/ionic liquids/any other polar aprotic solvents based electrolyte. In an embodiment, the electrolyte is a carbonate-based electrolyte.

In an embodiment, the electrode material further comprises a carbon matrix.

Preferably, the electrode is an anode and the anode material may further comprise any other additives that may be suitable when forming the sodium ion battery. For example, an electrically conductive additives (e.g. carbon black, acetylene black, graphite, carbon nanopowder, graphene, carbon, nitrogen-doped carbon), and/or a binder may be present at any suitable proportions and amounts.

In another aspect of the present invention, there is provided a sodium-ion battery comprising (a) an anode; (b) a cathode; (c) a separator disposed between the anode and the cathode, the separator is configured to conduct sodium ions; and (d) an electrolyte, wherein the anode comprises a material, the material comprising a sodium titanate having the formula Na₃₊ₓTi₃O₇, wherein the value of x is defined as −0.5≦x≦0.3.

Preferably, the material is an intermediate phase between Na₂Ti₃O₇ and Na₄Ti₃O₇ when cycled against a cathode material having a higher voltage in an electrolyte. The electrolyte may be a carbonate-based electrolyte. Preferably, the cathode material is a sodium metal.

In yet another aspect of the present invention, there is provided a method of producing an electrode for a sodium ion battery, the method comprising: (a) providing a sodium source and a titanium source; and (b) reacting the sodium source and titanium source in a solvo-thermal reaction in the presence of a carbon source and a medium to form a sodium titanate electrode material, wherein the electrode is formed by loading the sodium titanate electrode material with a conductive additive and a binder.

Preferably, the sodium source is sodium hydroxide and the titanium source is titanium isopropoxide.

Preferably, the conductive addictive is a Super P carbon and the binder is a sodium salt of carboxymethyl cellulose (CMC).

Preferably, the electrode material is Na₂Ti₃O₇. More preferably, the electrode is an anode, and the material forms an intermediate phase between Na₂Ti₃O₇ and Na₃₊ₓTi₃O₇ when cycled against a cathode material having a higher voltage in an electrolyte, wherein the value of x is defined as −0.5≦x≦0.3. Preferably, the electrode is an anode, and the material forms an intermediate phase between Na₂Ti₃O₇ and Na₄Ti₃O₇. Still more preferably, the intermediate phase is Na₃Ti₃O₇.

Preferably, the electrolyte is a carbonate-based electrolyte.

Preferably, the weight ratio of the electrode material, Super P carbon and CMC may be 80:10:10, or 70:20:10. Alternatively, any other suitable weight ratio may be used.

The electrode formed from the above method may be used to form a sodium ion battery. Such sodium ion batteries may be applied in stationary grids or micro-grids, or in other applications such as in electric vehicles or consumer electronics are straightaway relevant. Other relevant uses could be in lithium-ion batteries, electrochromic windows, water splitting or catalyst reactions.

The present invention includes any material having the formula Na₃₊ₓTi₃O₇ with ‘x’ denoting the fact that a range of stoichiometries may be possible (−0.5≦x≦0.3, hence from Na_{2.5}Ti₃O₇ to Na_{3.3}Ti₃O₇). It should be recognized that all electrochemical, chemical or mechanical means to synthesize this Na₃₊ₓTi₃O₇ are included. As an example, we will present the electrochemical conversion of Na₂Ti₃O₇, prepared from a solvo-thermal reaction, to Na₃Ti₃O₇ when cycled against sodium metal in a carbonate based electrolyte. In addition to its use as an anode in NIBs, its application to LIBs, electrochromic windows, water splitting and catalytic reactions will also be covered.

In order that the present invention may be fully understood and readily put into practical effect, there shall now be described by way of non-limitative examples only preferred embodiments of the present invention, the description being with reference to the accompanying illustrative figures.

In the Figures:

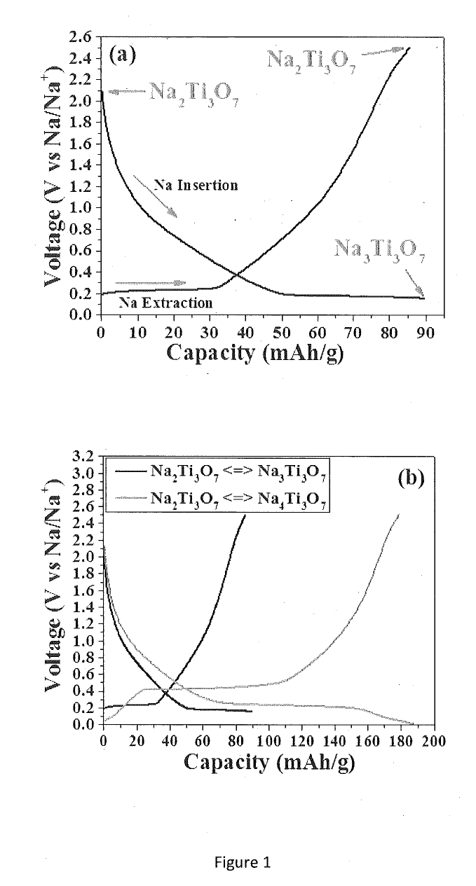

FIG. 1. Illustration of the electrochemical conversion of Na₂Ti₃O₇ to Na₃Ti₃O₇ (a). Comparison of the different galvanostatic profiles obtained for the Na₂Ti₃O₇<=>Na₃Ti₃O₇ sodium storage mechanism, with respect to the known Na₂Ti₃O₇<=>Na₄Ti₃O₇ sodium storage mechanism (shown in (b)). The difference in the voltage polarization is obvious. Cycling data is presented at C/5 rate for all instances and cycled in a coin cell with sodium metal acting as the counter and reference electrodes.

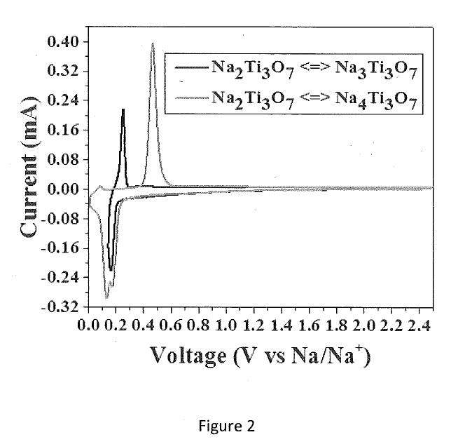

FIG. 2. Cyclic voltammograms for the two different sodium storage pathways. The existence of separate oxidation and reduction peaks clearly reveals the differences in the operating potential between these two mechanisms.

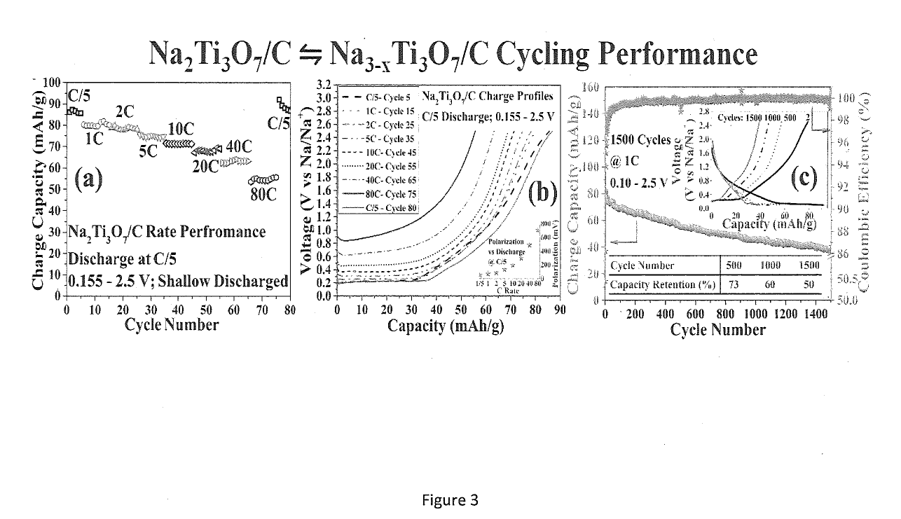

FIG. 3. Rate Performance of the Na₂Ti₃O₇<=>Na₃Ti₃O₇ sodium storage mechanism where Na₂Ti₃O₇ has been prepared by a solvo-thermal approach which results in a carbon matrix (hence titled Na₂Ti₃O₇/C). FIG. 3(a) presents the capacity obtained at different C rates while FIG. 3 (b) displays the corresponding galvanostatic charging curves. Discharge was performed at C/5 rate. FIG. 3 (c) Long term cycling of this pathway with corresponding cycling curves as inset. As can be seen, excellent stability at all rates and less polarization even at extremely fast charging rates of 40 and 80 C are displayed.

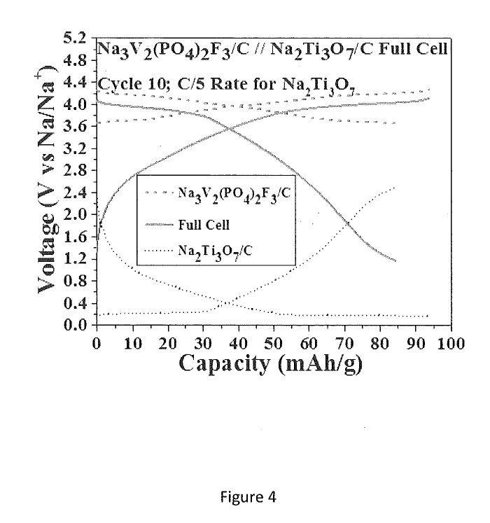

FIG. 4. Galvanostatic cycling curves of a full sodium-ion cell fabricated in a three-electrode configuration comprising Na₃V₂(PO₄)₂F₃/C as the cathode, Na₂Ti₃O₇/C as the anode and sodium metal as the reference electrode. The cycling curves of the cathode, the anode as well as that of the resultant full cell are presented. By limiting the sodium uptake in Na₂Ti₃O₇ such that the Na₂Ti₃O₇<=>Na₃Ti₃O₇ sodium storage mechanism operates, an extremely high voltage plateau is obtained between 4.0-3.7 V in a full cell. The current was calculated as C/5 for the anode.

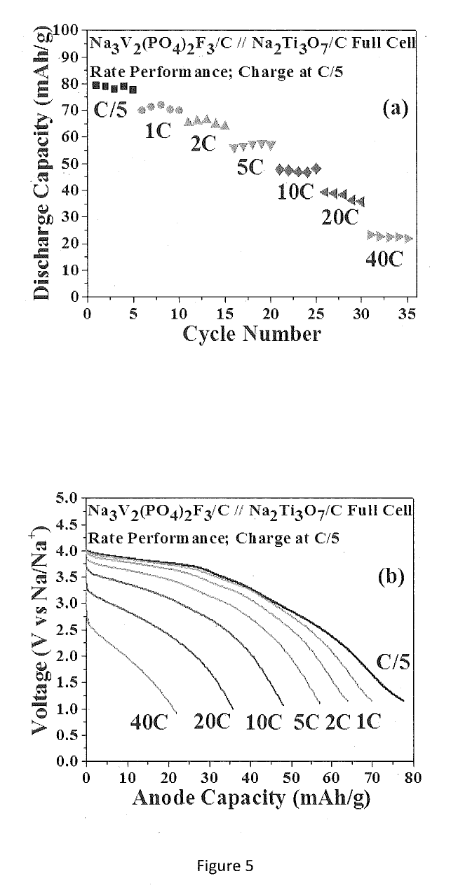

FIG. 5. Rate performance for the full sodium-ion cell comprising Na₃V₂(PO₄)₂F₃/C as the cathode and Na₂Ti₃O₇/C as the anode with the Na₂Ti₃O₇<=>Na₃Ti₃O₇ sodium storage mechanism in operation. FIG. 5 (a) displays the discharge capacity of the full cell at different C rates. Please note that the capacity is calculated with respect to just the anode weight. FIG. 5 (b) presents the corresponding galvanostatic discharge curves of the full cell. In each case, the charging was performed galvanostatically at a C/5 rate with respect to the anode.

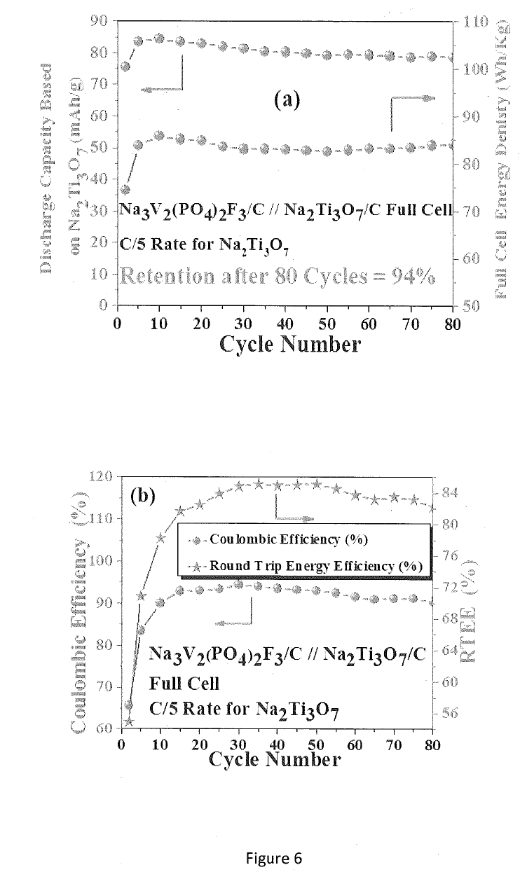

FIG. 6. Long term galvanostatic charge-discharge cycling curves for the full sodium-ion cell comprising Na₃V₂(PO₄)₂F₃/C as the cathode and Na₂Ti₃O₇/C as the anode with the Na₂Ti₃O₇<=>Na₃Ti₃O₇ sodium storage mechanism in operation. FIG. 6(a) presents the stable cycling at C/5 rate demonstrating the discharge capacity based on the anode weight, as well as the full cell's energy density, based on the weight of the cathode and the anode. FIG. 6(b) exhibits the corresponding coulombic efficiency and RTEE of the full cell. As can be seen, a stable RTEE close to 85% exists throughout the cycling.

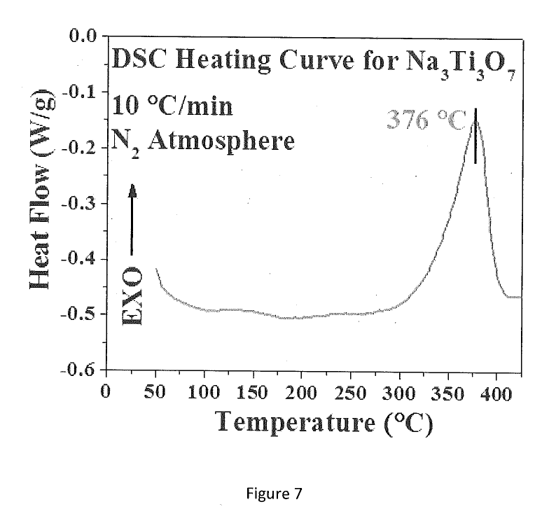

FIG. 7. Differential Scanning calorimetry (DSC) curve for Na₃Ti₃O₇ demonstrates the material's excellent thermal stability, with an exothermic peak existing only at 376° C. Such a high temperature should ensure that a full cell with this material will not be in a danger of thermal runaway.

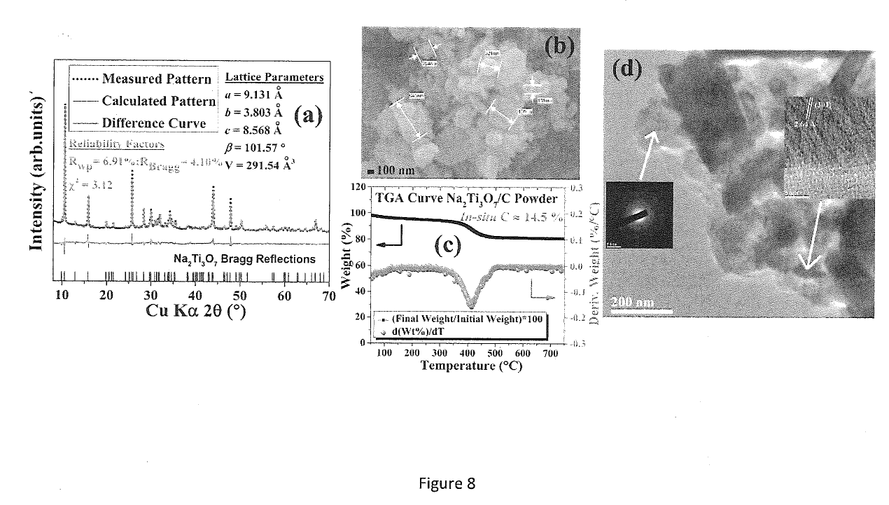

FIG. 8. Material characterization of the as-synthesized Na₂Ti₃O₇/C with (a) Rietveld analysis on XRD pattern, (b) FESEM, (c) TGA and (d) HRTEM and SAED showing single crystalline Na₂Ti₃O₇ platelet embedded in amorphous carbon matrix.

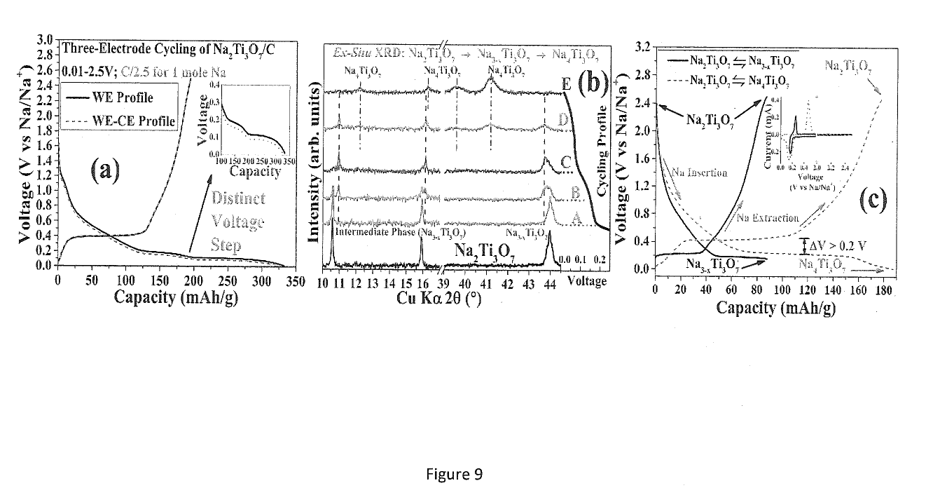

FIG. 9. (a) Three-electrode galvanostatic cycling of Na₂Ti₃O₇/C with enlarged view of the voltage step as inset. (b) Ex-situ XRD patterns at various points along deep discharged Na₂Ti₃O₇. (c) Representative C/5 cycling (not the first cycle) of Na₂Ti₃O₇⇄Na₃₋ₓTi₃O₇ and Na₂Ti₃O₇⇄Na₄Ti₃O₇ pathways with corresponding CV curves as inset.

### EXAMPLE

A new sodium storage pathway is presented here for the anode Na₂Ti₃O₇ which involves the newly discovered intermediate phase of Na₃₋ₓTi₃O₇. Details about this Na₂Ti₃O₇⇄Na₃₋ₓTi₃O₇ sodium storage pathway and how it relates to the conventional Na₂Ti₃O₇⇄Na₄Ti₃O₇ pathway are described below. This Na₂Ti₃O₇⇄Na₃₋ₓTi₃O₇ pathway has the lowest redox voltage of 0.2 V vs Na/Na⁺ ever reported for any non-carbon based sodium-ion battery anode along with moderately high capacity approaching 89 mAh/g, negligible polarization, excellent rate performance (up to 80 C, or 45 s response) and good cycle life till 1,500 cycles. These results indicate this pathway's potential as an anode for sodium-ion batteries meant for diverse applications.

### 1. METHODS AND MATERIALS

Na₃Ti₃O₇ can be conveniently prepared electrochemically from Na₂Ti₃O₇. FIG. 1 details how this can be achieved. When cycled against sodium metal in an appropriate electrolyte, Na₂Ti₃O₇ can be forced to accept sodium ions. As this proceeds, the galvanostatic cycling profile will continually shift to lower potentials. Finally, at about 0.19 V vs Na/Na⁺ when cycled at a C/5 rate corresponding to 1 mole Na insertion into Na₂Ti₃O₇ (17.8 mA/g), the beginnings of a voltage plateau will be noticed, which continues till about 0.155 V vs Na/Na⁺. Based on the amount of charge passed during this time, one can calculate that Na₂Ti₃O₇ has been transformed to Na₃Ti₃O₇. Confirmation of this new phase has been obtained by X-ray diffraction (XRD). Upon charging, Na₃Ti₃O₇ converts back to Na₂Ti₃O₇, with a charge plateau occurring at about 0.22 V at a C/5 rate. Na₂Ti₃O₇ can convert to unwanted Na₄Ti₃O₇ if discharging current is allowed to pass beyond the stated cut-off potential and will exhibit another plateau around 0.1 V in its first cycle (refer to the CV curves in FIG. 2). To obtain the Na₂Ti₃O₇<=>Na₃Ti₃O₇ sodium storage pathway, one would need to be wary of when to stop sodium insertion, as demonstrated in FIG. 1.

Na₂Ti₃O₇ prepared from any means, be it solid-state reaction, hydro/solvo-thermal reaction etc. and with/without any carbon as a surface coating or a composite matrix will exhibit the characteristics displayed above. As an example, we have taken a solvo-thermally synthesized Na₂Ti₃O₇ embedded in a carbon matrix, labelled as “Na₂Ti₃O₇/C”. Also, the material properties of Na₃Ti₃O₇, such as its morphology or surface area, which was synthesized electrochemically from Na₂Ti₃O₇, would depend on the material properties of Na₂Ti₃O₇ which may be subject to changes due to the synthesis. Another point to note is that the stated lower cut-off voltage may be found to be variable as it depends on the applied C rate of discharge, electrode thickness, ratio of conductive additive to Na₂Ti₃O₇ present in the electrode, quality of cell fabrication, morphology of the synthesized Na₂Ti₃O₇ as well as on the electrolyte used. Depending on these variables, it is possible for the lower cut-off voltage to stretch to as low as 0.0 V vs Na/Na⁺ to witness the Na₂Ti₃O₇<=>Na₃Ti₃O₇ storage pathway.

Therefore, in an embodiment of the present invention, Na₂Ti₃O₇/C was synthesized using a solvo-thermal approach. The sodium and titanium sources were sodium hydroxide (32 mg) and titanium isopropoxide (296 μl) respectively taken in stoichiometric molar ratio with 20% molar excess of the former. Gluconic acid lactone (285 mg) was used as in-situ carbon source and absolute ethanol (15.3 ml) served as the medium. The reaction was carried out in a Teflon® vessel (26 ml) sealed in a stainless steel autoclave at 180° C. for 6 h and allowed to cool naturally. The resulting solution with precipitates was centrifuged once with absolute ethanol and then dried in an oven kept at 70° C. for 4 h. The obtained orange-light brown powder was then calcined at 800° C. for 4 h under argon gas flow in a tube furnace to yield the final product. Composite electrodes were made with the as-synthesized powder:Super P carbon:sodium salt of carboxymethyl cellulose (CMC) in the weight ratio 80:10:10 with the loading of Na₂Ti₃O₇ being about 1.5-2.0 mg/cm². 1M NaClO₄ in EC:PC (1:1 v/v) was used as the electrolyte. For ex-situ XRD studies, solid-state synthesized Na₂Ti₃O₇ was used in order to obtain better reflection intensities owing to its micrometer-sized particles. These electrodes had the weight ratio 70:20:10 (Na₂Ti₃O₇:Super P carbon:CMC) and were cycled to respective states of discharge at C/5. The electrodes were opened in a glove box, covered with Kapton tape and all XRD patterns reported were obtained within 3 min as the discharged electrodes were found to be very unstable in air. The Kapton tape cover delayed phase transformation to Na₂Ti₃O₇ long enough to obtain reliable XRD patterns. Please note that the same ex-situ XRD experiments were performed on the Na₂Ti₃O₇/C electrodes prepared from the solvothermal synthesis and the results were identical as that with solid-state synthesized Na₂Ti₃O₇. However, owing to its sub-micrometric particle size, the signal-to-noise ratio was quite low and hence, this data have not been shown. All other relevant experimental information has been published previously.

### 2. RESULTS

As depicted in FIG. 8a, Rietveld refinement of the structural model with the XRD pattern collected on the as-synthesized material suggests that pure phase of Na₂Ti₃O₇ was obtained in the P121/m₁ space group with good refinement reliability factors and lattice parameters consistent with the earlier reported work. Field Emission Scanning Electron Microscopy (FESEM) image (FIG. 8b) reveals sub-micrometric particle dimensions while Thermogravimetric Analysis (TGA) curve indicates the as-synthesized material contained about 14.5 wt % of in-situ carbon (FIG. 8c). This combination of Na₂Ti₃O₇ with in-situ carbon is termed “Na₂Ti₃O₇/C” henceforth. Selected Area Electron Diffraction (SAED) and High Resolution Transmission Electron Microscopy (HRTEM) revealed the single crystalline Na₂Ti₃O₇ platelets surrounded by carbon (FIG. 8d) existing as an amorphous matrix (revealed by diffuse SAED rings).

The first galvanostatic cycle of Na₂Ti₃O₇/C cycled in a three-electrode cell between 2.5 and 0.01 V (deep discharged) is depicted in FIG. 9a at C/2.5 rate (corresponding to one mole sodium storage per formula unit based on theoretical capacity of 88.9 mAh/g). In this voltage window, Na₂Ti₃O₇ can accommodate two moles of sodium, resulting in a charge (Na extraction) capacity of 178 mAh/g, consistent with previous reports. Please note that the long first cycle discharge is due to electrolyte decomposition at such reducing voltages resulting in solid electrolyte interphase (SEI) formation on the anode and is not related to irreversible sodium uptake by Na₂Ti₃O₇. A closer look at the discharge (Na intercalation) profile reveals a distinct voltage step (see inset of FIG. 9a). In fact, this voltage step can also be clearly seen in the first discharge profiles of this material in other reports. Such a voltage step is not related to the voltage step phenomenon reported by us previously as the step arises from the working electrode (WE), not the sodium metal counter electrode (CE), and the WE-CE profile smoothly follows that of the WE. This observation implies that there must be an intermediate phase existing between Na₂Ti₃O₇ and deep discharged Na₄Ti₃O₇, as there are two separate discharge plateaus.

To confirm this observation, ex-situ XRD patterns were collected at different stages of discharge (FIG. 9b). As discharge proceeded, the reflections associated with the parent Na₂Ti₃O₇ phase decreased in intensity. Simultaneously, new sets of reflections appeared at 2θ=10.93, 16.10 and 43.72° and increased in intensity along the upper discharge plateau at the expense of those belonging to the parent Na₂Ti₃O₇ phase (see patterns collected at points A, B and C in FIG. 9b). At the end of the upper discharge plateau with the transformation of Na₂Ti₃O₇ to the intermediate phase, the reflections of Na₂Ti₃O₇ disappeared (point C). Hence, it appears that sodium storage in Na₂Ti₃O₇ along the upper discharge plateau proceeds through a two-phase reaction mechanism and that the intermediate phase is a stable phase that forms at the end of the upper discharge plateau. Further discharge from point C (onto the lower discharge plateau represented by points D and E) systematically gave rise to a new set of reflections at 2θ=12.2, 16.23, 39.56 and 41.17° while those belonging to the intermediate phase decreased progressively before disappearing. These new reflections are consistent with those reported for Na₄Ti₃O₇ implying that sodium storage along the lower discharge plateau is also two-phase in nature. Therefore, in the course of sodium intercalation, Na₂Ti₃O₇ exhibits two different voltage plateaus, with each plateau associated with a different two-phase reaction mechanism.

Indeed, if the lower cut-off voltage is limited to around 0.155 V (shallow discharged) at C/5 instead of 0.01 V such that the material is allowed to intercalate sodium until the end of the upper discharge plateau (till the voltage step), the resulting galvanostatic profile of the charge curve is completely different (FIG. 9c). The shallow discharged material now displays a flat charging plateau at 0.22 V, contrary to the 0.44 V plateau witnessed for Na₂Ti₃O₇ that was deep discharged to 0.01 V. Cyclic voltammetry (CV) curves (inset of FIG. 9c) support the notion of a distinctly different oxidation-reduction mechanism operating, with a clear oxidation peak at 0.24 V for the shallow discharged as opposed to that at 0.47 V for the deep discharged Na₂Ti₃O₇. The obtained capacity of 87 mAh/g during charge indicates that almost one mole of sodium was inserted in the Na₂Ti₃O₇/C composite electrode during discharge, nominally forming “Na₃₋ₓTi₃O₇/C”. Please note that the amorphous carbon matrix may have taken part in sodium storage. However, since the same Na₂Ti₃O₇/C composite electrode delivered 178 mAh/g during charge if deep discharged (meaning two moles of sodium were inserted in Na₂Ti₃O₇ to form the established and well-understood phase Na₄Ti₃O₇ at its deep discharged state), we do believe that the intermediate phase's composition formed during shallow discharge is Na₃₋ₓTi₃O₇ with x≈0 (i.e., Na₃Ti₃O₇). Confirmation of the crystal structure and exact amount of sodium in the intermediate phase Na₃₋ₓTi₃O₇ is currently in progress through in-situ XRD measurements.

The fact that two discharge plateaus are witnessed upon deep discharge corresponding to the Na₂Ti₃O₇→Na₃₋ₓTi₃O₇ and Na₃₋ₓTi₃O₇→Na₄Ti₃O₇ two-phase reactions respectively, but only the 0.44 V charge plateau (corresponding to that for the established Na₄Ti₃O₇→Na₂Ti₃O₇ two-phase reaction) is witnessed during charge, implies an irreversible transition during deep discharge to 0.01 V which causes the Na₂Ti₃O₇⇄Na₃₋ₓTi₃O₇ pathway to be lost in subsequent cycles. If this was not the case, the charge cycle of a deep discharged Na₂Ti₃O₇ electrode should have also displayed two separate charge plateaus. The different phases (Na₂Ti₃O₇, Na₃₋ₓTi₃O₇ and Na₄Ti₃O₇) involved in the sodium storage in Na₂Ti₃O₇ may give rise to different sodium migration routes which would likely affect the chemical diffusion of sodium in them. This may help explain the large difference seen in the polarization of the Na₂Ti₃O₇⇄Na₃₋ₓTi₃O₇ and Na₂Ti₃O₇⇄Na₄Ti₃O₇ pathways. Atomistic simulation studies on the resolved crystal structure of Na₃₋ₓTi₃O₇ from the in-situ XRD experiments would help in resolving this point. In summary, during deep discharge, Na₂Ti₃O₇ forms the distinct phases of Na₃₋ₓTi₃O₇ and Na₄Ti₃O₇, but during charge, Na₄Ti₃O₇ transforms to Na₂Ti₃O₇ directly without formation of the Na₃₋ₓTi₃O₇ phase. Hence, to witness the Na₂Ti₃O₇⇄Na₃₋ₓTi₃O₇ pathway over many cycles, it is imperative that the irreversible transformation of Na₃₋ₓTi₃O₇ to Na₄Ti₃O₇ is avoided by appropriately limiting the extent of sodiation during discharge (by limiting the voltage window).

The charge plateau close to 0.2 V makes the Na₂Ti₃O₇⇄Na₃₋ₓTi₃O₇ pathway the lowest redox voltage non-carbon based NIB anode ever reported, being 0.2 V lower than the previous lowest voltage non-carbon anode, viz. the Na₂Ti₃O₇⇄Na₄Ti₃O₇ pathway demonstrating its charge plateau above 0.4 V. The close proximity of the oxidation and reduction peaks for the Na₂Ti₃O₇⇄Na₃₋ₓTi₃O₇ pathway as revealed by CV implies lower polarization and good reversibility. Indeed, as seen from FIG. 3a and FIG. 3b, the Na₂Ti₃O₇⇄Na₃₋ₓTi₃O₇ pathway demonstrates stable charge capacities of 86, 80, 78, 75, 71, 69, 64 and 55 mAh/g at various rates 1/5, 1, 2, 5, 10, 20, 40 and 80 C, respectively. In particular, its polarization became significant only at 40 and 80 C (inset of FIG. 3b). In fact, this pathway's polarization at a fast 10 C rate was the same as that displayed by the Na₂Ti₃O₇⇄Na₄Ti₃O₇ pathway at its slowest cycling rates. This low polarization will be advantageous towards achieving high energy and power densities if this pathway is used in full cells. Furthermore, this pathway exhibited quite stable cycling at 1 C rate with capacity retention of 73, 60 and 50% after 500, 1,000 and 1,500 cycles respectively along with stable coulombic efficiency exceeding 99.5% and negligible increase in polarization (FIG. 3c). Please note that such a long cycle life is reported for the first time for any NIB anode demonstrating the majority of its charge capacity below 0.8 V vs Na/Na⁺, to the best of our knowledge. At such low voltages, the stability and passivating ability of the SEI is a critical parameter towards achieving long cycle life. It is expected that optimization of the electrolyte would further improve its cycling stability beyond the 1,500 cycles already demonstrated with no special electrolyte additives. Hence, we believe that the Na₂Ti₃O₇⇄Na₃₋ₓTi₃O₇ pathway could be a serious contender as an anode for various NIB applications.

In addition to the above, the present Na₂Ti₃O₇<=>Na₃Ti₃O₇ sodium storage mechanism demonstrates extremely good rate performance with little polarization even at high rates and stable cycling at all rates, as demonstrated in FIG. 3 and described above. The material is also stable over many cycles. When this reaction mechanism is utilized in a full cell, a very high full cell plateau can be obtained between 4.0-3.7 V as exhibited in FIG. 4 when paired with an appropriate cathode and it demonstrates stable cycling over many cycles with a high energy density of around 85 Wh/Kg, based on the weight of the cathode and the anode alone, as well as an excellent RTEE around 85% (refer to FIG. 6). The rate performance in a full cell is also extremely impressive, as depicted in FIG. 5. Lastly, this material (Na₃Ti₃O₇) is thermally very stable, displaying an exothermic peak only around 376° C. (seen in FIG. 7) which is much higher than that displayed by sodiated carbon (around 100-150° C.). Hence, the combination of its low cost (being based on sodium and titanium, which are abundant elements), safety, very low voltage plateaus demonstrating little polarization, good stability over many cycles and a high RTEE when employed in a full cell, makes the Na₂Ti₃O₇<=>Na₃Ti₃O₇ as a very promising anode material for sodium-ion battery applications.

Due to its superior properties involving intercalation and redox based reactions (as demonstrated by sodium intercalation), it is expected that this newly discovered compound Na₃Ti₃O₇ may display very favourable performance in other applications which require one or both of these properties, such as in electrochromic windows, water splitting or catalyst reactions.

By storing two moles of sodium per formula unit through a two-phase reaction mechanism between Na₂Ti₃O₇ and Na₄Ti₃O₇, Na₂Ti₃O₇ has a high capacity (178 mAh/g) and low and flat voltage of 0.4 V vs Na/Na⁺ upon sodium extraction. The major drawback of this material is its high polarization greater than 0.2 V. In fact, it has been proposed that the polarization is thermodynamically controlled (independent of particle size) and may not be below 0.225 V. Furthermore, the fully sodiated phase, Na₄Ti₃O₇, has been shown to be unstable due to self-relaxation which may be the reason for its poor cycle life. Advantageously, the present invention results in a new sodium storage mechanism for a previously known compound (Na₂Ti₃O₇) which not only results in superior sodium storage properties, but also results in the discovery of a new compound (Na₃Ti₃O₇). When used as an anode material for sodium-ion battery application, this invention takes part in the lowest ever reported redox voltage activity for sodium storage for a non-carbon based anode material demonstrating excellent high rate performance as well as good stability over many cycles. When used in a full NIB paired with a high voltage cathode such as Na₃V₂(PO₄)₂F₃, the highest voltage full sodium-ion cell ever fabricated using non carbon-based electrodes results which has obvious implications for not only a high energy density NIB, but also for powering loads which may not work if the voltage of a battery is too low. This anode supports high rate operation of NIB. Although voltage can always be increased by connecting identical cells in parallel, one would certainly require less of them in parallel for supplying current for high voltage needs, such as for grid storage batteries. These facts, along with the high RTEE exhibited by this reaction mechanism in a full NIB along with its inherent safety, would make the findings of this invention as the most suitable choice for a commercial high voltage NIB meant for grid storage batteries.

### 3. CONCLUSION

An intermediate phase has been discovered and isolated through galvanostatic cycling studies of Na₂Ti₃O₇ in a sodium battery. This new anode reaction for Na₂Ti₃O₇ results in it storing sodium via a two-phase reaction mechanism between the phases Na₂Ti₃O₇⇄Na₃₋ₓTi₃O₇ and demonstrates the lowest charge plateau ever reported for any non-carbon based NIB anode at 0.2 V vs Na/Na⁺. Ex-situ XRD analysis revealed that Na₂Ti₃O₇ undergoes two separate two-phase reactions in its very first discharge which results in two separate discharge plateaus separated by a faint voltage step. The lower discharge plateau causes an irreversible transformation which leads to the loss of the Na₂Ti₃O₇⇄Na₃₋ₓTi₃O₇ sodium storage pathway in subsequent cycles. If this is avoided by restricting the voltage window, then the Na₂Ti₃O₇⇄Na₃₋ₓTi₃O₇ pathway is capable of storing almost one mole of sodium resulting in ≈89 mAh/g capacity along with minimal polarization, an ultra-fast 80 C (45 s) response and a cycle life of 1,500 cycles at 1 C. This pathway's combination of earth-abundant elements, low voltage, decent capacity, good cycling stability and excellent rate performance would make it a promising NIB anode which could be used for diverse applications.

Whilst there has been described in the foregoing description preferred embodiments of the present invention, it will be understood by those skilled in the technology concerned that many variations or modifications in details of design or construction may be made without departing from the present invention.

1. An electrode material for a sodium ion battery, the material comprising a sodium titanate having the formula Na₃₊ₓTi₃O₇, wherein the value of x is defined as −0.5≦x≦0.3.

2. The electrode material according to claim 1, wherein the sodium titanate has a formula of Na₃Ti₃O₇.

3. The electrode material according to any one of claim 1 or 2, wherein the electrode is an anode, and the material is an intermediate phase between Na₂Ti₃O₇ and Na₃₊ₓTi₃O₇ when cycled against a cathode material having a higher voltage in an electrolyte.

4. The electrode material according to claim 3, wherein the electrolyte is a carbonate-based electrolyte.

5. The electrode material according to claim 3, wherein the cathode material is a sodium metal.

6. The electrode material according to any one of the preceding claims, wherein the material further comprises a carbon matrix.

7. A sodium-ion battery comprising
(a) an anode;
(b) a cathode;
(c) a separator disposed between the anode and the cathode, the separator is configured to conduct sodium ions; and
(d) an electrolyte,
wherein the anode comprises a material, the material comprising a sodium titanate having the formula Na₃₊ₓTi₃O₇, wherein the value of x is defined as −0.5≦x≦0.3.

8. The battery according to claim 7, wherein the material is an intermediate phase between Na₂Ti₃O₇ and Na₄Ti₃O₇ when cycled against a cathode material having a higher voltage in a carbonate-based electrolyte.

9. The battery according to claim 8, wherein the cathode material is a sodium metal.

10. A method of producing an electrode for a sodium ion battery, the method comprising:
(a) providing a sodium source and a titanium source; and
(b) reacting the sodium source and titanium source in a solvo-thermal reaction in the presence of a carbon source and a medium to form a sodium titanate electrode material,
wherein the electrode is formed by loading the sodium titanate electrode material with a conductive additive and a binder.

11. The method according to claim 10, wherein the sodium source is sodium hydroxide and the titanium source is titanium isopropoxide.

12. The method according to any one of claim 10 or 11, wherein the conductive addictive is a Super P carbon and the binder is a sodium salt of carboxymethyl cellulose (CMC).

13. The method according to any one of claims 10 to 12, wherein the electrode material is Na₂Ti₃O₇.

14. The method according to claim 13, wherein the electrode is an anode, and the material forms an intermediate phase between Na₂Ti₃O₇ and Na₃₊ₓTi₃O₇ when cycled against a cathode material having a higher voltage in an electrolyte, wherein the value of x is defined as −0.5≦x≦0.3.

15. The method according to claim 14, wherein the electrolyte is a carbonate-based electrolyte.

16. The method according to any one of claims 10 to 15, wherein the weight ratio of the electrode material, Super P carbon and CMC is 80:10:10, or 70:20:10.

17. An electrode obtained by a method according to any one of claims 10 to 16.

18. The electrode according to claim 17, wherein the electrode is an anode.

19. A battery comprising an anode, an electrolyte and a cathode, wherein the anode is an electrode according to claim 17.
